(19) United States
(12) Patent Application Publication
(10) Pub. No.: US 2019/0316403 A1
(43) Pub. Date: Oct. 17, 2019

(54) DEVICE FOR DETERMINING POSITION OF LIFTGATE OR REAR DOOR OF A CARGO TRUCK OR TRAILER

(71) Applicant: Nicholas A. Aiello, Valencia, CA (US)

(72) Inventor: Nicholas A. Aiello, Valencia, CA (US)

(21) Appl. No.: 15/952,822

(22) Filed: Apr. 13, 2018

(51) Int. Cl. E05F 7/00; B60Q 1/30

(52) U.S. Cl. CPC E05F 7/00; B60J 5/108; B60Q 1/30

(57) ABSTRACT

A device for determining the position of a rear door or liftgate of a cargo truck or trailer includes a base attachable to the rear door or liftgate. A visual indicator extends from the base so as to be viewable from a side view mirror of the truck to enable a driver of the truck to determine the position of the rear door or liftgate due to the position of the visual indicator. The visual indicator may be a plurality of closely spaced apart elongated members, which may be brightly colored or light transmissive so as to be easily seen.

### BACKGROUND OF THE INVENTION

The present invention generally relates to liftgates and rear doors of cargo trucks and semi-trailers and the like. More particularly, the present invention is directed to a device for determining the position of a rear door or liftgate of such cargo trucks or trailers.

It is well known that large vans, cargo trucks, trailers attachable to semi-trucks and the like vehicles have large doors at the rear end thereof for loading and unloading objects. Such doors are often in the form of rolling doors, which can be rolled upward to open the rear end of the truck or trailer and rolled downward to close the same, or have a barn door arrangement, wherein two doors are hinged at their outer edge and swing inwardly towards a closed position and outwardly towards an open position. Typically, such doors open the rear end of the vehicle or trailer to the greatest extent possible so as to be able to fit large objects therein.

Such vehicles are often raised to a significant degree from the ground. Loading docks are often of a height corresponding to roughly the lower edge of the truck or trailer, such that cargo and other items can be loaded and unloaded easily from the van, truck bed, trailer, etc. and into the warehouse or the facility having the loading dock. However, in some cases the loading dock is not of a corresponding height, or there is no loading dock at the place where the goods are to be loaded or unloaded. In those cases, a liftgate, sometimes referred to as a tail lift, can be very useful. A liftgate is a mechanical device permanently fitted to the back of a van, cargo truck or trailer which is designed to facilitate the handling of goods from ground level or a loading dock to the level of the load bed of the vehicle, or vice versa. The majority of liftgates are hydraulic or pneumatic in operation, although they can be mechanical, and are controlled by an operator using an electric relay switch. The use of a liftgate can obviate the need to use machinery, such as a forklift, in order to load heavy items onto a vehicle, or can be used to bridge the difference in height between the vehicle load bed and the loading dock or ground. A platform of the liftgate is lowered from a vertical position to a generally horizontal position and then raised or lowered between the height of the vehicle load bed and the loading dock and/or ground level to load and unload goods.

A problem periodically encountered with the doors and liftgates of such vans, cargo trucks and trailers is that it is not readily determinable from the cab of the truck if the doors are closed or the liftgate is moved into a vertical and stored position. Mistakes are commonly made due to the operator of the vehicle being in a rush, or negligent forgetfulness. Inadvertently leaving a rollup door or barn doors open while driving can result in goods within the cargo hold falling out of the van, truck or trailer. This not only presents a possible loss in property, but also presents a safety issue to drivers in the area. If the vehicle's liftgate is not in the proper stowed position, the liftgate can become damaged or damage other property around it if the vehicle is moved. This also presents safety issues.

Accordingly, there is a continuing need for the driver of the vehicle to be able to confirm the position of the barn or roll door of the vehicle, and the vehicle's liftgate while seated in the cab of his or her vehicle prior to departure. The present invention fulfills these needs, and provides other related advantages.

### SUMMARY OF THE INVENTION

The present invention is related to a device for determining the position of a door or liftgate of a cargo truck or trailer or the like. The device generally comprises a base attachable to a rear door or liftgate of a cargo truck or truck trailer. A visual indicator extends from the base so as to be viewable from a side view mirror of the truck enabling a driver of the truck to determine the position of the rear door or liftgate due to the position of the visual indicator.

The base is comprised of a mounting plate attachable to the rear door or liftgate, and an upper plate attachable to the mounting plate over a portion of the visual indicator. A retainer may be disposed between the mounting plate and the upper plate that retains a first end portion of the visual indicator therein. The mounting plate and/or upper plate may include a recessed portion to receive the retainer and/or a portion intermediate the ends of the visual indicator therein.

In a particularly preferred embodiment, the visual indicator comprises a plurality of closely spaced apart elongated members. The visual indicator may extend between four and eighteen inches from the base. Preferably, the visual indicator is brightly colored so as to be easily seen.

At least one of the elongated members of the visual indicator may be light transmissive. An end thereof is associated with the light source for transmitting light therethrough. The light source may be coupled to an electronic circuit disposed within the base. The visual indicator may comprise at least one fiber optic cable. A solar panel may be attached to or associated with the base for providing power to the electronic circuit and light source.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a top perspective view of a device for determining the position of a liftgate or rear door of a cargo truck or trailer embodying the invention;

FIG. 2 is a cross-sectional view of the device of FIG. 1;

FIG. 3 is a partially exploded perspective view of components of the device;

FIG. 4 is another exploded perspective view of a device embodying the present invention in which visual indicators thereof are illuminated;

FIG. 5 is a rear view of a cargo truck having the device of the present invention attached to a liftgate thereof;

FIG. 6 is a rear diagrammatic view illustrating devices of the present invention attached to a rollup door of a cargo truck or trailer; and

FIG. 7 is a diagrammatic rear view of a truck or trailer having barn doors with the device of the present invention attached thereto.

### DETAILED DESCRIPTION OF THE PREFERRED EMBODIMENTS

The present invention, as shown in the drawings for purposes of illustration, is directed to a device which enables a driver within the cab of his or her truck or van to determine the position of the vehicle's or trailer's door or liftgate. The device alerts and notifies the driver of the position of the door and/or liftgate of the vehicle.

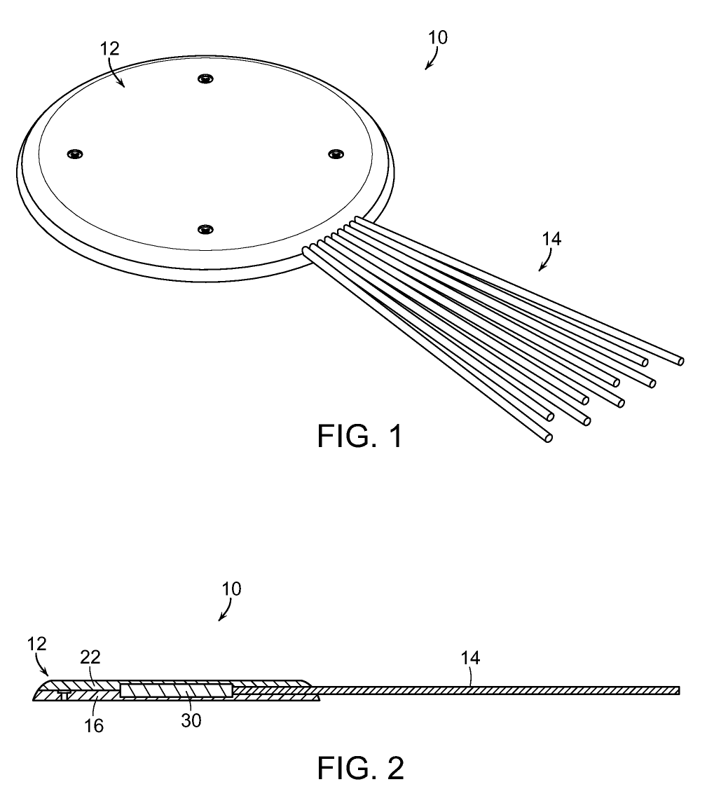

With reference now to FIGS. 1 and 2, in a particularly preferred embodiment, the device 10 comprises a base 12 which is attachable to the door and/or liftgate and which includes a visual indicator 14 extending therefrom so as to be viewable in the side view mirror of the cab of the vehicle. The base 12 is attachable to a portion of the rear door or liftgate, while the visual indicator 14 extends a sufficient distance to extend beyond the edge of the trailer or cargo bed of the vehicle and be seen in the side view mirror from the cab of the vehicle.

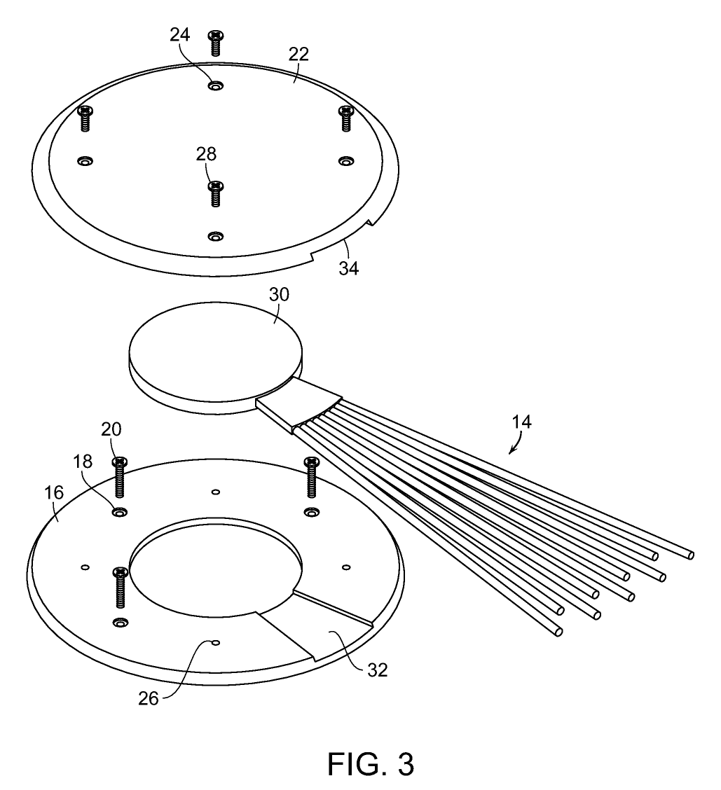

With reference to FIGS. 1-3, the base 12 may be comprised of a mounting plate 16 which is attachable to the roll door, barn door, liftgate or the like. This may be by any known means, including magnets, adhesives, welding, etc. In the embodiment illustrated in FIG. 3, apertures 18 extend through the mounting plate 16 for insertion of fasteners 20, such as screws, bolts or the like. When screw fasteners 20 are utilized, they can be directly screwed into a rear door of the cargo truck or trailer which is comprised of a material receptive to receiving the threaded screw, such as wood or the like. In other cases, holes may be drilled into the liftgate, rear door or the like and the fastener 20 comprises a bolt having a nut attached to the end thereof after the bolt is inserted through the mounting plate 16 and the door or liftgate.

An upper plate 22 may be connected to the mounting plate 16. The upper plate 22 may be connected to the mounting plate 16 in a variety of manners, including snap-fit connection, or the like. However, in the illustrated embodiment, apertures 24 are formed through the upper plate 22 which are alignable with apertures 26 formed in the mounting plate 16 through which fasteners 28 extend so as to removably attach the upper plate 22 to the mounting plate 16.

Typically the base 12 is comprised of a rigid, durable but relatively inexpensive material, such as a plastic material, including polycarbonate or the like. However, it will be appreciated that other materials, such as metals, etc. could be used instead. The base 12 should be sufficiently durable for use, but relatively inexpensive so as to keep the cost of installing or replacing the device reasonable.

The mounting plate 16 and the upper plate 22 sandwich an end and a portion of the visual indicators 14 therebetween. In a particularly preferred embodiment, the base 12 comprises the mounting plate 16 and upper plate 22 as separate pieces which are removably attached to one another so as to insert the retaining ends of the one or more visual indicators 14 therebetween, or a retainer member 30 which is attached to the retaining ends and portion of the one or more visual indicators 14. However, it will be understood, that the base 12 could be comprised of a single, integrally formed member from which the one or more visual indicators 14 extend. For example, the base 12 could be molded around the ends of the visual indicators 14. However, in a particularly preferred embodiment, as illustrated, the base 12 is comprised of the mounting plate 16 and upper plate 22 which are detachably connected to one another such that as the one or more visual indicators 14 need to be replaced the upper plate 22 can be detached from the mounting plate 16 and the one or more visual indicators 14 replaced as needed. It is anticipated that over time the visual indicators 14 may become damaged and broken due to exposure to the sun, weather, coming into contact with other objects and the like. While the entire device 10 could be replaced, it would provide a cost savings to only have to replace the one or more visual indicators 14 or the unit comprising the visual indicators 14 and the retaining member 30.

Typically, the visual indicators 14 comprise elongated members, such as cables, rods or the like. The visual indicators 14 may be comprised of a substantially rigid or resilient material so as to extend generally horizontal or parallel with the road in order to be readily seen. These may be comprised of a plastic material which may be of a bright color or painted a bright color which can be readily seen from the cab of the vehicle. The visual indicators 14, as indicated above, extend out from the base 12 a distance from the side of the truck sufficient so as to be viewed from a side view mirror, example, of the truck cab. Thus, the distance of the one or more visual indicators 14 may be several inches to up to a foot or more in length, such as between four and eighteen inches. However, the visual indicators 14 should not be of such a length so as to become an obstacle to oncoming traffic, adjacent cars, and other objects adjacent to the vehicle. Typically, a length of approximately four inches to eighteen inches is sufficient so as to be seen but not present a hazard.

Although there can be as few as a single visual indicator 14, in a particularly preferred embodiment there are a plurality of visual indicators 14 which are spaced apart from one another, as illustrated. This renders the visual indicators 14 to be more easily seen. Moreover, if one of the visual indicators 14 breaks, the driver of the vehicle will still be able to view the other visual indicators. The visual indicators 14 are preferably comprised of a material which is substantially rigid so as to extend generally horizontal and parallel with the ground surface, but has a degree of flexibility so as to withstand damage due to wind or coming into contact with other objects or the like. The visual indicators 14 may extend substantially co-planar. When the device 10 is installed upon the liftgate or rear door of the cargo truck or trailer or the like, while the visual indicators 14 extend generally parallel to the ground surface, the plane formed by the plurality of the visual indicators 14 are generally vertical with respect to the ground surface, such that the driver can easily see the visual indicators 14. However, if the liftgate or door is pivoted to another location, the visual indictors 14 will move from this generally vertical plane to a more parallel plane to the ground surface, which will also benefit the driver of the vehicle in determining if the liftgate, door or the like is in a closed position.

With reference again to FIG. 3, the mounting plate 16 and/or the upper plate 22 may include recesses 32 and 34 which receive the visual indicators 14 therein. As illustrated, both the mounting plate 16 and upper plate 22 include such recesses 32 and 34 for receiving a portion of the retainer member 30 therein. The retainer member 30 may be molded onto the retaining ends of the visual indicators 14, or may be comprised of two shells which are attachable to one another so as to retain the ends of the visual indicators 14 therein. The visual indicators 14 may be molded into grooves or recesses formed in one of the shells of the retaining member 30.

It is contemplated by the present invention that the one or more visual indicators 14 could be comprised of a material which is capable of carrying and/or transmitting light. In such a case, a light source, such as an LED, could be housed within the base 12 and provide a source of illuminating the one or more visual indicators 14, which could comprise fiber optic cables or other such materials which could transmit light. In such a case, the visual indicators 14 would not only be visible during the daylight hours, but would also be viewable during the nighttime hours as well.

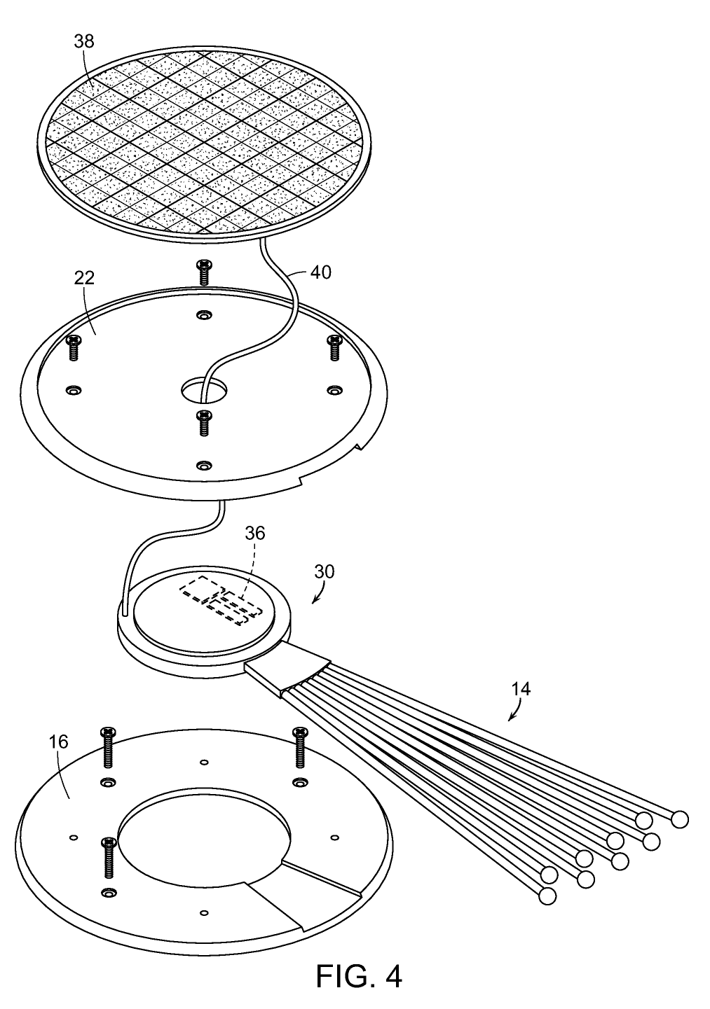

With reference now to FIG. 4, an embodiment of the device 10 of the present invention is shown wherein the visual indicators 14 are comprised of fiber optic cables or other material which can transmit light such that the visual indicators 14 are visible in the dark. The visual indicators 14 may be comprised of a material which is translucent so as to have a color and visually seen during the daylight but also sufficiently lit during the evening so as to be viewed in the dark. Alternatively, colored light is transmitted through translucent or clear visual indicators 14 so that they are visible both during the daytime as well as at night. An electronic circuit 36 having the necessary electronic components and light source, such as one or more LEDs, is disposed within the base 12, such as in the retaining member 30. The light source is disposed adjacent to a retained end of the visual indicators 14 so as to transmit light into the ends thereof such that the light will travel a length of the visual indicators 14 so as to illuminate the visual indicators 14.

A power source is operably coupled to the electronic circuit 36 to provide power thereto. The power source may comprise one or more batteries. However, in one embodiment, the power source comprises a solar panel 38 comprised of solar cells which generate electricity from exposure to the sun and provide electricity to the electronic circuit 36. The electronic circuit 36 may include a rechargeable battery or the like to store the energy acquired during the daylight hours for use during the night. The solar panel 38 is associated with the device 10, such as being mounted on the outer surface of the base 12, such as the outer surface of the upper plate 22, as shown. Electric wires or cables 40, as necessary, electrically couple the solar panel 38 with the electronic circuit 36 or rechargeable battery. Use of a solar panel 38 eliminates the need to replace batteries periodically, and is also environmentally friendly.

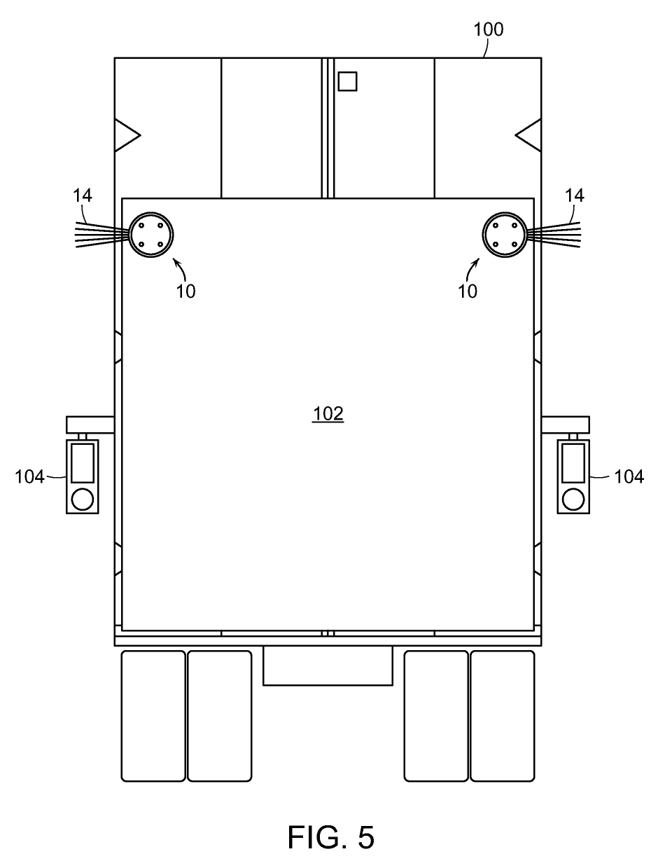

With reference now to FIG. 5, a vehicle 100, such as a cargo truck, semi-truck, van or the like, is shown having a liftgate 102 at a back end thereof. The device 10 of the present invention is installed on the liftgate 102. Preferably, the device is installed at an upper portion of the liftgate 102 near an edge thereof such that the visual indicators 14 extend beyond the edge of the trailer or cargo portion of the truck 100 so as to be easily seen by the side view mirror 104 of the truck. When the driver of the truck sees that the visual indicators 14 are at an appropriate upward position, the driver knows that the liftgate 102 has been closed. However, if the liftgate is in an extended, in-use and open position, the visual indicators 14 will be positioned below their uppermost position, which will be easily seen by the driver through the side view mirror 104. Moreover, instead of being able to view a plurality of visual indicators 14 spaced apart from one another along a plane which is generally perpendicular to the ground surface, if the liftgate 102 is in its completely opened and in-use state, it will be moved from a generally vertical position to a generally horizontal position, and thus the visual indicators 14 will also be at a generally horizontal plane with respect to the ground. In either case, the driver from within the cab of the vehicle can see the visual indicators 14 from his or her side view mirror 104 and be notified and aware of the position of the liftgate 102 due to the position of the visual indicators 14. If the visual indicators 14 are at a lowered position, or cannot be readily seen, the driver will be notified and can exit the cab of the vehicle 100 in order to fully close the liftgate 102 before departure.

It will also be appreciated by those skilled in the art that when the liftgate 102 is in its in-use position, typically generally horizontal, the extension of the visual indicators 14 from the corners or edges of the liftgate will also serve as a visual indicator to those walking around or operating machinery adjacent to the liftgate. The liftgates are often painted black or of a dark color and occasionally individuals will accidentally walk into the liftgates or hit the liftgates with the machinery. The use of the visual indicators 14 and device 10 of the present invention can reduce or eliminate the occurrences of these events.

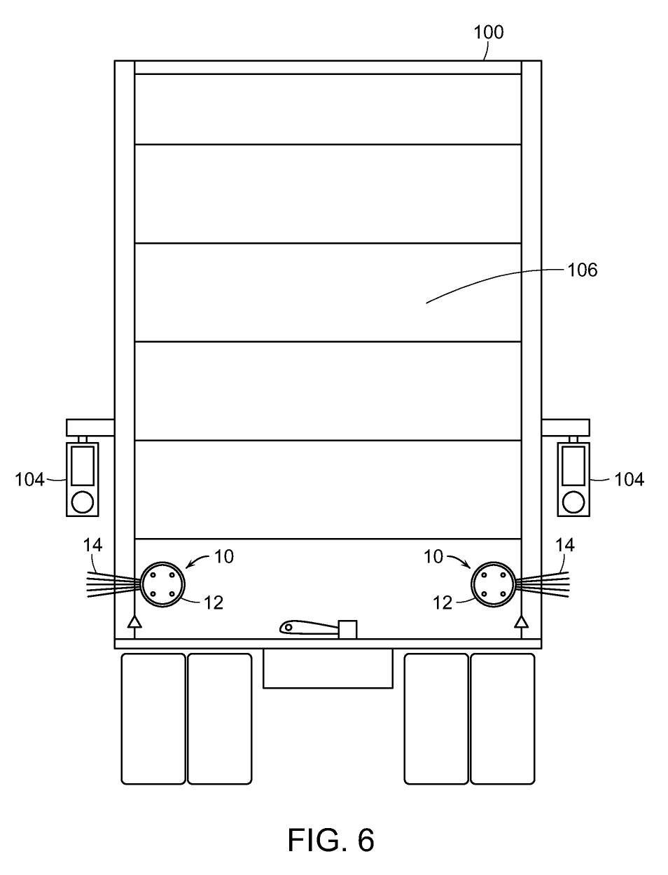

With reference now to FIG. 6, a vehicle 100 is shown with a roll door 106, comprised of a plurality of members hinged to one another and capable of being rolled up to open the trailer or cargo compartment or pull down to close the same. Unlike the liftgate situation of FIG. 5, in this case the device 10 of the present invention will preferably be attached to one or more lower corners of the rolling door 106, as illustrated. With the device 10 installed in the lower one or more corners of the rolling door 106, the driver of the vehicle 100 from his or her side view mirror 104 can see the visual indicators 14, and when they are in the lowered position will readily know that the rolling door 106 has been closed. However, if the visual indicators 14 are elevated the driver will immediately know that the rolling door 106 has not been fully closed and can exit the vehicle and close and lock the rolling door before departure.

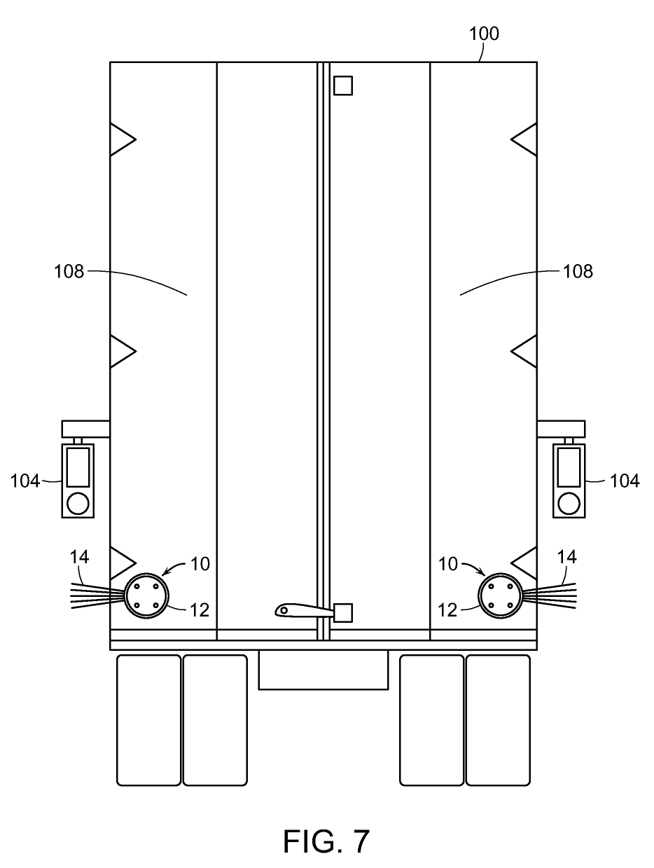

With reference now to FIG. 7, a vehicle 100 having barn-style doors 108 is illustrated with the device 10 of the present invention installed thereon. Although the device 10 of the present invention is illustrated at a lower portion of each door 108, it will be understood that the relative position along the height of each barn door 108 is not critical so long as the visual indicators 14 can be viewed from the side view mirrors 104. Whereas a single device 10 may be utilized in connection with a liftgate 102 or rolling door 106 as illustrated in FIGS. 5 and 6, which single device 10 will enable the driver to see the visual indicators 14 thereof in a side view mirror, preferably the side view mirror 104 on the driver's side of the vehicle 100, in the case with the barn-style doors 108, which utilizes two doors which pivot outwardly, preferably a device 10 is associated with each of the doors 108 which can be viewed from the side view mirrors 104 of the driver side as well as the passenger side of the cab of the vehicle 100.

With continuing reference to FIG. 7, when the doors 108 are fully closed, as illustrated, the visual indicators 14 extend out generally horizontal with respect to the road or ground surface. However, when the barn-style doors 108 are partially or fully open, the visual indicators 14 will become increasingly parallel to the side wall of the trailer or cargo bed, becoming more difficult to see. Thus, the driver of the vehicle 100 will be able to readily determine visually from looking in his or her side view mirrors 104 if the barn style doors 108 have been closed completely, and if not correct the problem before departure.

It will be readily apparent to those skilled in the art that the device 10 of the present invention is simple yet effective in allowing drivers to visually be aware of the position of the liftgate or door prior to setting in motion. The device 10 simply attaches to the liftgate or door itself. The device is an inexpensive yet effective answer to the ongoing safety concern. The device 10 is clearly visible from the side view mirrors of the cab and easily makes a driver aware of the rear assembly of the truck. Use of the device of the present invention is believed to lessen the loss of damaged property as well as making the transportation industry a safer place for all.

Although several embodiments have been described in detail for purposes of illustration, various modifications may be made without departing from the scope and spirit of the invention. Accordingly, the invention is not to be limited, except as by the appended claims.

What is claimed is:

1. A device for determining the position of a door or liftgate of a cargo truck or trailer, comprising:
a base attachable to a rear door or liftgate of a cargo truck or truck trailer; and
a visual indicator extending from the base so as to be viewable from a side view mirror of the truck enabling a driver of the truck to determine the position of the rear door or liftgate due to the position of the visual indicator.

2. The device of claim 1, wherein the base is comprised of a mounting plate attachable to the rear door or liftgate and an upper plate attachable to the mounting plate over a portion of the visual indicator.

3. The device of claim 2, including a retainer disposed between the mounting plate and upper plate that retains a first end portion of the visual indicator therein.

4. The device of claim 3, wherein the mounting plate and/or upper plate include a recessed portion to receive the retainer and a portion intermediate the ends of the visual indicator therein.

5. The device of claim 1, wherein the visual indictor comprises a plurality of closely spaced apart elongated members.

6. The device of claim 1, wherein the visual indicator extends between 4 and 18 inches from the base.

7. The device of claim 1, wherein the visual indicator is brightly colored so as to be easily seen.

8. The device of claim 1, wherein the visual indicator is light transmissive and has an end thereof associated with a light source for transmitting light therethrough.

9. The device of claim 8, wherein the visual indicator comprises at least one fiber optic cable.

10. The device of claim 8, wherein the light source is coupled to an electronic circuit disposed within the base.

11. The device of claim 10, including a solar panel attached to or associated with the base for providing power to the electronic circuit and light source.

12. A device for determining the position of a door or liftgate of a cargo truck or trailer, comprising:
a base attachable to a rear door or liftgate of a cargo truck or truck trailer; and
a visual indicator comprising a plurality of closely spaced apart elongated members extending from the base so as to be viewable from a side view mirror of the truck enabling a driver of the truck to determine the position of the rear door or liftgate due to the position of the visual indicator;
wherein the base is comprised of a mounting plate attachable to the rear door or liftgate and an upper plate attachable to the base plate over a portion of the visual indicator.

13. The device of claim 12, including a retainer disposed between the mounting plate and upper plate that retains a first end portion of the visual indicator therein.

14. The device of claim 13, wherein the mounting plate and/or upper plate include a recessed portion to receive the retainer and a portion intermediate the ends of the visual indicator therein.

15. The device of claim 12, wherein each of the visual indicators extends between 4 and 18 inches from the base.

16. The device of claim 12, wherein the elongated members of the visual indicator are brightly colored so as to be easily seen.

17. The device of claim 12, including an electronic circuit coupled to a light source associated with an end of the visual indicator within the base to transmit light through at least one of the elongated members that is light transmissive.

18. The device of claim 17, including a solar panel attached to or associated with the base for providing power to the electronic circuit and light source.
